(19) United States
(12) Patent Application Publication
(10) Pub. No.: US 2003/0157944 A1
(43) Pub. Date: Aug. 21, 2003

(54) Portable communication apparatus, external apparatus connectable to the portable communication apparatus, and method of controlling the portable communication apparatus

(75) Inventors: Masatoshi Nakao, Hino-shi (JP); Satoshi Funayama, Sagamihara-shi (JP)

Correspondence Address: BANNER & WITCOFF, 1001 G STREET N W, SUITE 1100, WASHINGTON, DC, 20001, US

(73) Assignee: Kabushiki Kaisha Toshiba, Minato-ku (JP)

(21) Appl. No.: 10/367,935

(22) Filed: Feb. 19, 2003

(30) Foreign Application Priority Data
Feb. 19, 2002 (JP) 2002-041702

(51) Int. Cl. H04Q 7/20

(52) U.S. Cl. 455/456; 455/557

(57) ABSTRACT

A switch enables a first circuit and a second circuit to be connected to an antenna and a port. A first detecting unit detects whether the external apparatus is connected to the port and detect the type of the external apparatus connected to the port. A second detecting unit detects whether the first circuit or the second circuit is activated. A control section controls the switch, when the first detecting unit detects that the external apparatus is not connected to the port or when the detected type of the external apparatus is inadaptable for the circuit to be activated, the circuit to be activated is connected to the antenna and that, when the detected type of the external apparatus is adaptable for the circuit to be activated, the circuit to be activated is connected to the port.

### CROSS-REFERENCE TO RELATED APPLICATIONS

This application is based upon and claims the benefit of priority from the prior Japanese Patent Application No. 2002-41702, filed Feb. 19, 2002, the entire contents of which are incorporated herein by reference.

### BACKGROUND OF THE INVENTION

1. Field of the Invention

This invention relates to a portable communication apparatus, such as a portable telephone, with a port for connecting with an external apparatus, such as a maintenance apparatus, an external antenna, or a car kit, and to the external apparatus.

2. Description of the Related Art

A portable communication apparatus with the GPS (Global Positioning System) function includes a communication circuit for realizing ordinary mobile communication and a GPS receiving circuit for receiving a GPS signal. The communication circuit and GPS receiving circuit are each normally connected to a separate built-in antenna or selectively connected to a common built-in antenna.

Each of the communication circuit and GPS receiving circuit is generally designed to be connectable to an external apparatus, such as a maintenance apparatus for adjustment or test, an external antenna, or a car kit. Therefore, a portable communication apparatus is provided with a port to which such an external apparatus is to be connected. A conventional portable communication apparatus is provided with a port for connecting an external apparatus to the communication circuit and another port for connecting the external apparatus to the GPS receiving circuit.

As described above, both the port for the communication circuit and the port for the GPS receiving circuit had to be mounted on the conventional portable communication apparatus, which required a large mounting space. This prevented the portable communication apparatus from being made smaller in size.

Furthermore, a workman who was supposed to connect an external apparatus had to select a port to which the apparatus was to be connected, suitably according to the type of the external apparatus, which was not only troublesome task but also introduced the danger of making an error in connection.

### BRIEF SUMMARY OF THE INVENTION

The object of the present invention is to simplify a port for connecting with an external apparatus, while enabling a suitable connection between an internal circuit and the external apparatus, and further simplify the connecting work.

According to an aspect of the present invention, there is provided a portable communication apparatus comprising: a first circuit configured to communicate over a communication network; a second circuit configured to receive a position sensing signal; an antenna configured to be adaptable for both of the first and second circuits; a port configured to connect to an external apparatus; a switch configured to connect the first and second circuits to the antenna and the port; a first detecting unit configured to detect whether the external apparatus is connected to the port and detect a type of the external apparatus connected to the port; a second detecting unit configured to detect whether the first circuit or the second circuit is activated; and a control unit configured to control the switch, when the first detecting unit detects that the external apparatus is not connected to the port or when the detected type of the external apparatus is inadaptable for the circuit to be activated, the circuit to be activated is connected to the antenna and that, when the detected type of the external apparatus is adaptable for the circuit to be activated, the circuit to be activated is connected to the port.

According to another aspect of the present invention, there is provided a portable communication apparatus comprising: a first circuit configured to communicate over a communication network; a second circuit configured to receive a position sensing signal; an antenna configured to be adaptable for both of the first and second circuits; a port configured to connect with an external apparatus; a switch configured to connect the first and second circuits to the antenna and port; a first detecting unit configured to detect whether the external apparatus is connected to the port and detect a type of the external apparatus connected to the port; a second detecting unit configured to detect whether the first circuit or the second circuit is activated; and a control unit configured to control the switch, when it is detected that the second circuit is to be activated and the type of the external apparatus is adaptable for the second circuit, the second circuit is connected to the port and that, when it is detected that the type of the external apparatus is inadaptable for the second circuit, the second circuit is connected to the antenna.

According to still another aspect of the present invention, there is provided a method of controlling a portable communication apparatus including a first circuit configured to communicate over a communication network, a second circuit configured to receive a position sensing signal, an antenna configured to be adaptable for both of the first and second circuits, a port configured to connect with an external apparatus, and a switch configured to connect the first and second circuits to the antenna and port, the method comprising: detecting whether the external apparatus is connected to the port and detecting a type of the external apparatus connected to the port; detecting whether the first circuit or the second circuit is activated; and controlling the switch when it is detected that the external apparatus is not connected to the port or when the detected type of the external apparatus is inadaptable for the circuit to be activated, the circuit to be activated is connected to the antenna and that, when the detected type of the external apparatus is adaptable for the circuit to be activated, the circuit to be activated is connected to the port.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a configuration of the main part of a portable communication apparatus according to a first embodiment of the present invention;

FIGS. 2A and 2B show a state where each section is connected by the switch in FIG. 1;

FIG. 3 shows a state where the portable communication apparatus of the first embodiment is in a first used state;

FIG. 4 shows a state where the portable communication apparatus of the first embodiment is in a second used state;

FIG. 5 shows a state where the portable communication apparatus of the first embodiment is in a third used state;

FIG. 6 shows a configuration of the main part of a portable communication apparatus according to a second embodiment of the present invention;

FIG. 7 shows a configuration of the main part of a portable communication apparatus according to a third embodiment of the present invention and a configuration of the main part of a car kit as an external apparatus for the terminal; and

FIG. 8 is a flowchart for a switch control process.

### DETAILED DESCRIPTION OF THE INVENTION

Hereinafter, referring to the accompanying drawings, embodiments of the present invention will be explained.

(First Embodiment)

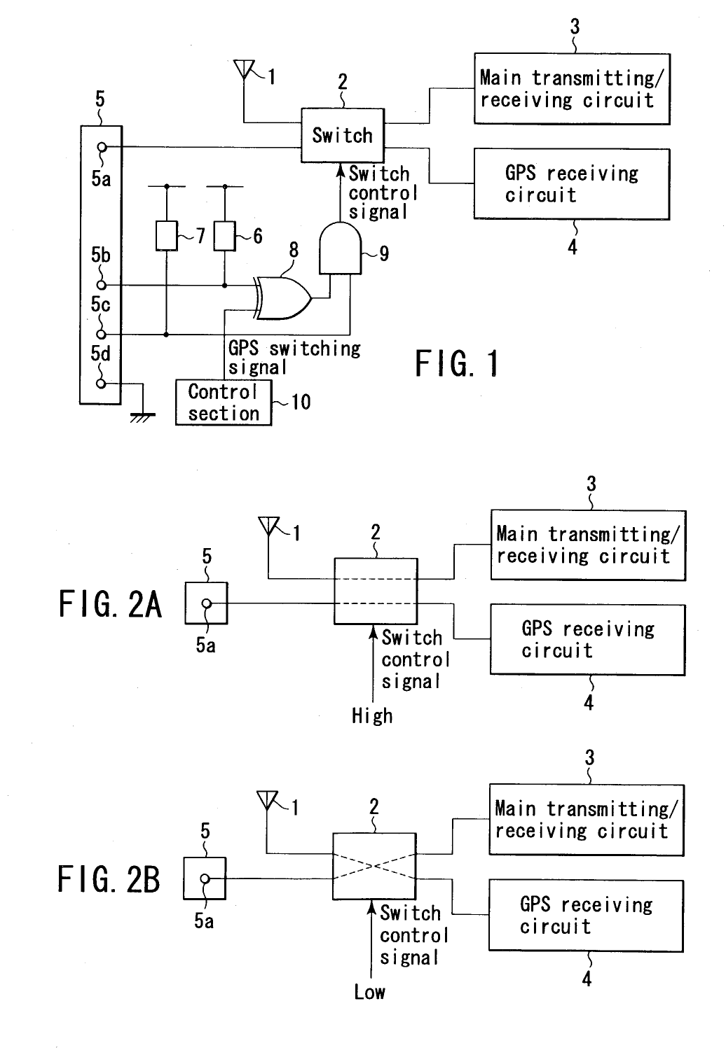

FIG. 1 shows a configuration of the main part of a portable communication apparatus according to a first embodiment of the present invention.

As shown in FIG. 1, the portable communication apparatus of the first embodiment comprises a built-in antenna 1, a switch 2, a main transmitting/receiving circuit 3, a GPS receiving circuit 4, an external connection port 5, pull-up resistances 6, 7, an EX-OR gate 8, an AND gate 9, and a control section 10.

The built-in antenna 1 is provided on the portable communication apparatus in a fixed manner. The built-in antenna 1 is adaptable for both the transmission and reception by the main transmitting/receiving circuit 3 and the reception by the GPS receiving circuit 4. That is, the main transmitting/receiving circuit 3 and the GPS receiving circuit 4 share the built-in antenna 1.

According to the state of a switch control signal, the switch 2 connects the built-in antenna 1 and external connection port 5 to the main transmitting/receiving circuit 3 and GPS receiving circuit 4 suitably.

FIG. 2 shows a state where each section is connected by the switch 2.

When the switch control signal is high, the switch 2 connects not only the built-in antenna 1 to the main transmitting/receiving circuit 3 but also the external connection port 5 to the GPS receiving circuit 4 as shown in FIG. 2A. When the switch control signal is low, the switch 2 connects not only the built-in antenna 1 to the GPS receiving circuit 4 but also the external connection port 5 to the main transmitting/receiving circuit 3 as shown in FIG. 2B.

The main transmitting/receiving circuit 3 carries out a communication process for realizing a normal mobile communication via a mobile communication network (not shown).

The GPS receiving circuit 4 carries out the process of receiving a GPS signal sent from a GPS satellite (not shown).

An external apparatus is connected to the external connection port 5 as needed. The external connection port 5 has terminals 5a, 5b, 5c, 5d. The terminal 5a is capable of parallel connection with a plurality of signal lines. The terminal 5a is connected via the switch 2 to the main transmitting/receiving circuit 3 or GPS receiving circuit 4. Each of the terminals 5b, 5c, 5d, is a terminal. The terminal 5b is connected to one end of the pull-up resistance 6 and a input terminal of the EX-OR gate 8. The terminal 5c is connected to one end of the pull-up resistance 7 and a input terminal of the AND gate 9. The terminal 5d is grounded.

The pull-up resistance 6, which is inserted between a power line at a voltage level corresponding to the High level and the terminal 5b, pulls up the terminal 5b.

The pull-up resistance 7, which is inserted between a power line at a voltage level corresponding to the High level and the terminal 5c, pulls up the terminal 5c.

One of the two input terminals of the EX-OR gate 8 is connected to the terminal 5b. A GPS switching signal outputted from the control section 10 is supplied to the other of the two input terminals of the EX-OR gate 8. When the terminal 5b is low, the EX-OR gate 8 outputs the logic of the GPS switching signal as it is. When the terminal 5b is high, the EX-OR gate 8 inverts the logic of the GPS switching signal and outputs the result.

One of the two input terminals of the AND gate 9 is connected to the terminal 5c. The other of the two input terminals of the AND gate 9 is connected to the output terminal of the EX-OR gate 8. The AND gate 9 allows the output from the EX-OR gate 8 to pass only when the terminal 5c is at the high level. The output of the AND gate 9 is supplied to the switch 2 as a switch control signal.

On the basis of an operation mode specified by the user or the like, the control section 10 determines which of the main transmitting/receiving circuit 3 or GPS receiving circuit 4 to activate. The control section 10 brings the GPS switching signal into the high level, when the GPS receiving circuit 4 is to be activated.

Next, the operation of the portable communication apparatus of the first embodiment configured as described above will be explained.

When no external apparatus is connected to the external connection port 5 as shown in FIG. 1, both of the terminals 5b and 5c are in the open state. Therefore, the terminals 5b, 5c are pulled up by the pull-up resistances 6, 7, with the result that they are at the high level.

Because the terminal 5b is at the high level, the logic of the GPS switching signal is inverted and the result is outputted from the EX-OR gate 8. In addition, because the terminal 5c is at the high level, the output from the EX-OR gate 8 passes through the AND gate 9 as it is and is supplied to the switch 2 as a switch control signal.

Thus, if the control section 10 puts the GPS switching signal at the low level to activate the main transmitting/receiving circuit 3, the switch control signal goes high. As a result, the switch 2 is in the state as shown in FIG. 2A, where the built-in antenna 1 is connected to the main transmitting/receiving circuit 3. That is, in this state, it is possible for the main transmitting/receiving circuit 3 to carry out a communication process using the built-in antenna 1 or to perform a normal communication operation via the mobile communication network.

In contrast, if the control section 10 puts the GPS switching signal at the high level to activate the GPS receiving circuit 4, the switch control signal goes low. As a result, the switch 2 is in the state as shown in FIG. 2B, where the built-in antenna 1 is connected to the GPS receiving circuit 4. That is, in this state, it is possible for the GPS receiving circuit 4 to receive a GPS signal using the built-in antenna 1 or to perform a position sensing operation.

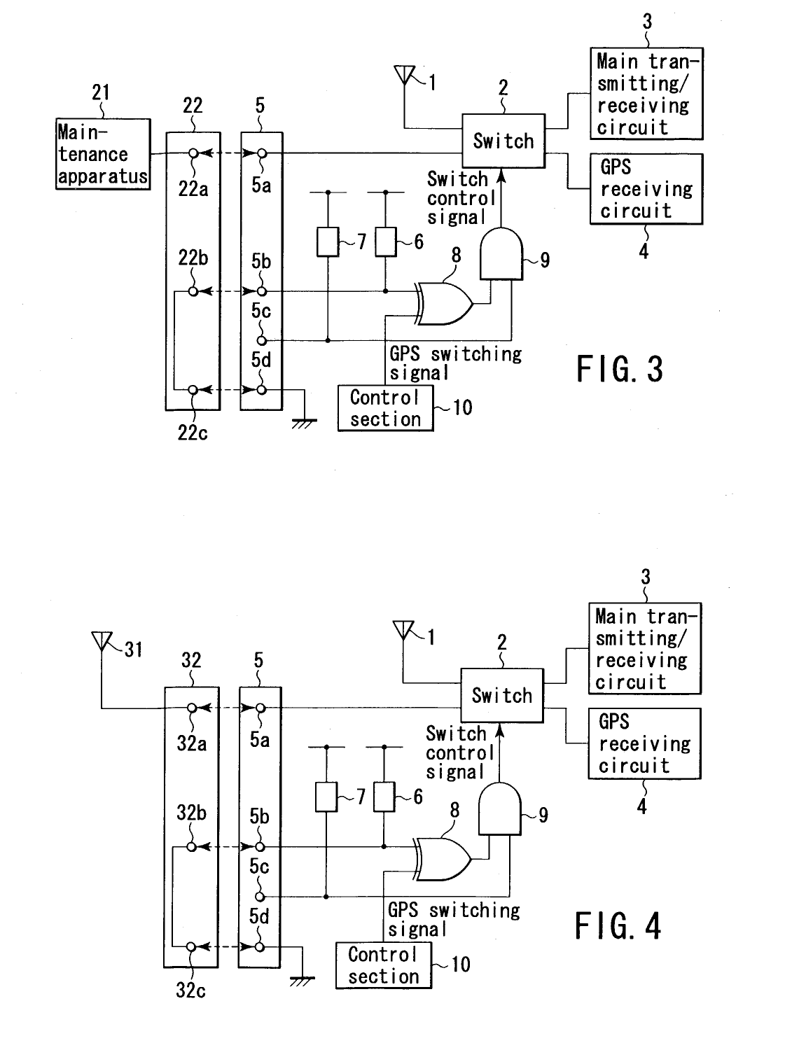

FIG. 3 shows a first used state of the portable communication apparatus of the first embodiment. In the first used state, a maintenance apparatus is connected to the external connection port 5.

In FIG. 3, reference numeral 21 indicates the maintenance apparatus. The maintenance apparatus 21, which is adaptable for both of the main transmitting/receiving circuit 3 and GPS receiving circuit 4, adjusts or tests these circuits 3, 4. The maintenance apparatus 21, which is provided with a connector 22, connects the connector 22 to the external connection port 5, thereby being connected to the portable communication apparatus.

The connector 22 has terminals 22a, 22b, 22c. The terminal 22a is capable of parallel connection with a plurality of signal lines. The terminal 22a is connected to the maintenance apparatus 21. The terminal 22a comes into contact with the terminal 5a when the connector 22 is connected to the external connection port 5. Each of the terminals 22b, 22c is a terminal. The terminals 22b and 22c are connected to each other. When the connector 22 is connected to the external connection port 5, the terminal 22b is connected to the terminal 5b and the terminal 22c is connected to the terminal 5d.

When the connector 22 is connected to the external connection port 5 as shown in FIG. 3, the terminal 5b is short-circuited to the terminal 5d via the connector 22. As a result, the terminal 5b is grounded, thereby going low. Because the terminal 5b is at the low level, the GPS switching signal is outputted as it is from the EX-OR gate 8. On the other hand, the connector 22 has no terminal making contact with the terminal 5c. As a result, the terminal 5c is pulled up by the pull-up resistance 7, thereby going high. Because the terminal 5c is at the high level, the output from the EX-OR gate 8 passes through the AND gate 9 as it is and is supplied to the switch 2 as a switch control signal.

When the main transmitting/receiving circuit 3 is activated, the control section 10 puts the GPS switching signal at the low level. At this time, the switch control signal is at the low level. As a result, the switch 2 is in the state shown in FIG. 2B, where the main transmitting/receiving circuit 3 is connected to the terminal 5a. In this state, the main transmitting/receiving circuit 3 is connected to the maintenance apparatus 21 via the external connection port 5 and connector 22. That is, use of the maintenance apparatus 21 enables the main transmitting/receiving circuit 3 to be adjusted or tested.

When the GPS receiving circuit 4 is activated, the control section 10 puts the GPS switching signal at the high level. At this time, the switch control signal is at the high level. As a result, the switch 2 is in the state shown in FIG. 2A, where the GPS receiving circuit 4 is connected to the terminal 5a. In this state, the GPS receiving circuit 4 is connected to the maintenance apparatus 21 via the external connection port 5 and connector 22. That is, use of the maintenance apparatus 21 enables the GPS receiving circuit 4 to be adjusted or tested.

FIG. 4 shows a second used state of the portable communication apparatus of the first embodiment. In the second used state, an external antenna is connected to the external connection port 5.

In FIG. 4, reference numeral 31 indicates the external antenna. The external antenna 31 is adaptable for both of the main transmitting/receiving circuit 3 and GPS receiving circuit 4. The external antenna 31, which is provided with a connector 32, connects the connector 32 to the external connection port 5, thereby being connected to the portable communication apparatus.

The connector 32 has terminals 32a, 32b, 32c. The terminal 32a is capable of parallel connection with a plurality of signal lines. The terminal 32a is connected to the external antenna 31. In addition, the terminal 32a comes into contact with the terminal 5a when the connector 32 is connected to the external connection port 5. Each of the terminals 32b, 32c is a terminal. The terminals 32b and 32c are connected to each other. When the connector 32 is connected to the external connection port 5, the terminal 32b is connected to the terminal 5b and the terminal 32c is connected to the terminal 5d.

When the connector 32 is connected to the external connection port 5 as shown in FIG. 4, the terminal 5b is short-circuited to the terminal 5d via the connector 32. As a result, the terminal 5b is grounded, thereby going low. Because the terminal 5b is at the low level, the GPS switching signal is outputted as it is from the EX-OR gate 8. On the other hand, the connector 32 has no terminal making contact with the terminal 5c. As a result, the terminal 5c is pulled up by the pull-up resistance 7, thereby going high. Because the terminal 5c is at the high level, the output from the EX-OR gate 8 passes through the AND gate 9 as it is and is supplied to the switch 2 as a switch control signal.

When the main transmitting/receiving circuit 3 is activated, the control section 10 puts the GPS switching signal at the low level. At this time, the switch control signal is at the low level. As a result, the switch 2 is in the state shown in FIG. 2B, where the main transmitting/receiving circuit 3 is connected to the terminal 5a. In this state, the main transmitting/receiving circuit 3 is connected to the external antenna 31 via the external connection port 5 and connector 32. That is, it is possible for the main transmitting/receiving circuit 3 to carry out a communication process by use of the external antenna 31.

When the GPS receiving circuit 4 is activated, the control section 10 puts the GPS switching signal at the high level. At this time, the switch control signal is at the high level. As a result, the switch 2 is in the state shown in FIG. 2A, where the GPS receiving circuit 4 is connected to the terminal 5a. In this state, the GPS receiving circuit 4 is connected to the external antenna 31 via the external connection port 5 and connector 32. That is, it is possible for the GPS receiving circuit 4 to receive a GPS signal by use of the external antenna 31.

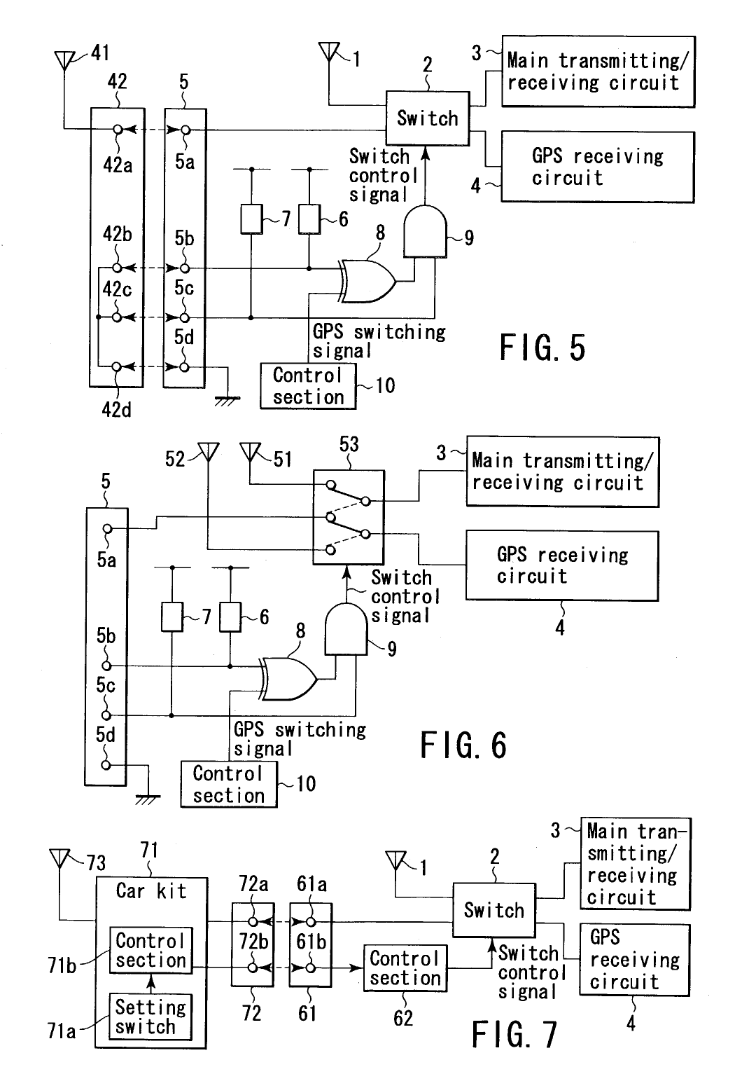

FIG. 5 shows a third used state of the portable communication apparatus of the first embodiment. In the third used state, an external antenna is connected to the external connection port 5.

In FIG. 5, reference numeral 41 indicates the external antenna. The external antenna 41 is adaptable only for the main transmitting/receiving circuit 3. The external antenna 41, which is provided with a connector 42, connects the connector 42 to the external connection port 5, thereby being connected to the portable communication apparatus.

The connector 42 has terminals 42a, 42b, 42c, 42d. The terminal 42a is capable of parallel connection with a plurality of signal lines. The terminal 42a is connected to the external antenna 41. In addition, the terminal 42a comes into contact with the terminal 5a when the connector 42 is connected to the external connection port 5. Each of the terminals 42b, 42c, 42d is a terminal. The terminals 42b, 42c, 42d are connected to one another. When the connector 42 is connected to the external connection port 5, the terminal 42b contacts the terminal 5b, the terminal 42c contacts the terminal 5c, and the terminal 42d contacts the terminal 5d.

When the connector 42 is connected to the external connection port 5 as shown in FIG. 5, the terminal 5b is short-circuited to the terminal 5d via the connector 42. As a result, the terminal 5b is grounded, thereby going low. Because the terminal 5b is at the low level, the GPS switching signal is outputted as it is from the EX-OR gate 8. The terminal 5c is short-circuited to the terminal 5d via the connector 42. As a result, the terminal 5c is grounded, going low. Because the terminal 5c is at the low level, the AND gate 9 is closed, with the result that the switch control signal is at the low level, regardless of the GPS switching signal.

Thus, the switch is always in the state shown in FIG. 2B, where the main transmitting/receiving circuit 3 is connected to the terminal 5a and the built-in antenna 1 is connected to the GPS receiving circuit 4. That is, in this state, when the main transmitting/receiving circuit 3 is in operation, a communication process can be carried out by use of the external antenna 41. Moreover, when the GPS receiving circuit 4 is in operation, it is possible to receive a GPS signal by use of the built-in antenna 1.

As described above, in the first embodiment, the switch 2 is capable of selectively connecting the main transmitting/receiving circuit 3 and GPS receiving circuit 4 to the built-in antenna 1 and external connection port 5. The external connection port 5 is provided with the terminals 5b, 5c, 5d. The terminals 5b, 5c are pulled up and the terminal 5d is grounded, thereby making it possible to sense whether the terminal 5b and the terminal 5d are short-circuited to each other and whether the terminal 5c and the terminal 5d are short-circuited to each other. On the external apparatus side, only the terminal 5b and the terminal 5d are short-circuited to each other in the connector 22, 32 in the case of the maintenance apparatus 21 and the external antenna 31 adaptable for the GPS receiving circuit 4. In the case of the external antenna 41 inadaptable for the GPS receiving circuit 4, the terminal 5b and the terminal 5d are short-circuited to each other and the terminal 5c and the terminal 5d are short-circuited to each other.

In this way, on the basis of the state where the terminal 5b and the terminal 5d are short-circuited and the terminal 5c and the terminal 5d are short-circuited, the connected state of an external apparatus can be verified as follows:

(1) If the terminal 5b and the terminal 5d are not short-circuited and the terminal 5c and the terminal 5d are not short-circuited, an external apparatus is not connected.

(2) If only the terminal 5b and the terminal 5d are short-circuited, an external apparatus adaptable for the GPS receiving circuit 4 is connected.

(3) If the terminal 5b and the terminal 5d are short-circuited and the terminal 5c and the terminal 5d are short-circuited, an external apparatus inadaptable for the GPS receiving circuit 4 is connected.

Then, on the basis of the state where the terminal 5b and the terminal 5d are short-circuited and the terminal 5c and the terminal 5d are short-circuited and of the GPS switching signal indicating whether the main transmitting/receiving circuit 3 or the GPS receiving circuit 4 is activated, the EX-OR gate 8 and AND gate 9 produce a switch control signal. The switch 2 is controlled by the switch control signal, which realizes the aforementioned various connection modes.

As described above, in the first embodiment, although the external connection port 5 is shared in connecting the main transmitting/receiving circuit 3 and the external apparatus and in connecting the GPS receiving circuit 4 and the external apparatus, the port 5 makes it possible to connect the main transmitting/receiving circuit 3 and the GPS receiving circuit 4 to the built-in antenna 1 and the external apparatus suitably.

Furthermore, with the first embodiment, a workman who is to connect an external apparatus to a portable communication apparatus has only to connect the external apparatus to the external connection port 5 in the same manner without taking the type of the external apparatus into consideration, which makes the work very simple and therefore prevents errors in the connection.

(Second Embodiment)

FIG. 6 shows a configuration of the main part of a portable communication apparatus according to a second embodiment of the present invention. In FIG. 6, the same parts as those in FIG. 1 are indicated by the same reference numerals and a detailed explanation of them will be omitted.

As shown in FIG. 6, the portable communication apparatus of the second embodiment comprises a main transmitting/receiving circuit 3, a GPS receiving circuit 4, an external connection port 5, pull-up resistances 6, 7, an EX-OR gate 8, an AND gate 9, a control section 10, a first built-in antenna 51, a second built-in antenna 52, and a switch 53.

Specifically, the portable communication apparatus of the second embodiment has the first built-in antenna 51 and second built-in antenna 52 in place of the built-in antenna 1 in the portable communication apparatus of the first embodiment and a switch 53 in place of the switch 2.

The first built-in antenna 51 is provided on the portable communication apparatus in a fixed manner. The first built-in antenna 51 is adaptable for the transmission and reception by the main transmitting/receiving circuit 3. The first built-in antenna 51 is inadaptable for the reception by the GPS receiving circuit 4.

The second built-in antenna 52 is provided on the portable communication apparatus in a fixed manner. The second built-in antenna 52 is adaptable for the reception by the GPS receiving circuit 4. The second built-in antenna 52 is inadaptable for the transmission and reception by the main transmitting/receiving circuit 3.

According to the state of a switch control signal, the switch 53 connects the first built-in antenna 51, second built-in antenna 52, and external connection port 5 to the main transmitting/receiving circuit 3 and GPS receiving circuit 4 suitably. Specifically, when the switch control signal is at the high level, the switch 53 is in a connection mode shown by solid lines in FIG. 6. When the switch control signal is at the low level, the switch 53 is in a connection mode shown by broken lines in FIG. 6.

Next, the operation of the portable communication apparatus of the second embodiment configured as described above will be explained.

In the portable communication apparatus of the second embodiment, too, a switch control signal is generated in the same manner as in the first embodiment.

Specifically, when no external apparatus is connected as shown in FIG. 6 and the control section 10 puts a GPS switching signal at the low level to activate the main transmitting/receiving circuit 3, the switch control signal is at the high level. As a result, the switch 53 is in the state of connection shown by solid lines in FIG. 6, where the first built-in antenna 51 is connected to the main transmitting/receiving circuit 3. In this state, it is possible for the main transmitting/receiving circuit 3 to carry out a communication process by use of the first built-in antenna 51. That is, it is possible for the main transmitting/receiving circuit 3 to perform a normal communication operation via a mobile communication network.

In contrast, when no external apparatus is connected as shown in FIG. 6 and the control section 10 puts the GPS switching signal at the high level to activate the GPS receiving circuit 4, the switch control signal is at the low level. As a result, the switch 53 is in the state of connection shown by broken lines in FIG. 6, where the second built-in antenna 52 is connected to the GPS receiving circuit 4. In this state, it is possible for the GPS receiving circuit 4 to receive a GPS signal by use of the second built-in antenna 52. That is, it is possible for the GPS receiving circuit 4 to carry out a position sensing operation.

When an external apparatus adaptable for both of the main transmitting/receiving circuit 3 and the GPS receiving circuit 4, such as the maintenance apparatus 21 of FIG. 3 or the external antenna 31 of FIG. 4, is connected and the control section 10 puts the GPS switching signal at the low level to activate the main transmitting/receiving circuit 3, the switch control signal is at the low level. As a result, the switch 53 is in the state of connection shown by broken lines in FIG. 6, where the main transmitting/receiving circuit 3 is connected to the terminal 5a. In this state, the main transmitting/receiving circuit 3 is connected to the external apparatus via the external connection port 5 and the connector 32.

In contrast, when an external apparatus adaptable for both of the main transmitting/receiving circuit 3 and the GPS receiving circuit 4 is connected and the control section 10 puts the GPS switching signal at the high level to activate the GPS receiving circuit 4, the switch control signal is at the high level. As a result, the switch 53 is in the state of connection shown by solid lines in FIG. 6, where the GPS receiving circuit 4 is connected to the terminal 5a. In this state, the GPS receiving circuit 4 is connected to the external apparatus via the external connection port 5 and the connector 32.

When an external apparatus adaptable only for the main transmitting/receiving circuit 3, such as the external antenna 41 in FIG. 5 is connected, the switch control signal is at the low level, regardless of the GPS switching signal. As a result, the switch 53 is always in the state of connection shown by broken lines in FIG. 6, where the main transmitting/receiving circuit 3 is connected to the terminal 5a and the second built-in antenna 52 is connected to the GPS receiving circuit 4. In this state, when the main transmitting/receiving circuit 3 is in operation, it is possible for the main transmitting/receiving circuit 3 to exchange signal with the external apparatus. Furthermore, when the GPS receiving circuit 4 is in operation, it is possible for the GPS receiving circuit 4 to receive a GPS signal by use of the second built-in antenna 52.

As described above, in the second embodiment, the switch 53 is capable of selectively connecting the main transmitting/receiving circuit 3 and GPS receiving circuit 4 to the first built-in antenna 51, second built-in antenna 52, and external connection port 5. The external connection port 5 is provided with the terminals 5b, 5c, 5d. The terminals 5b, 5c are pulled up and the terminal 5d is grounded, thereby making it possible to sense whether the terminal 5b and the terminal 5d are short-circuited to each other and whether the terminal 5c and the terminal 5d are short-circuited to each other.

Then, on the basis of the state where the terminal 5b and the terminal 5d are short-circuited and the terminal 5c and the terminal 5d are short-circuited and of the GPS switching signal indicating whether the main transmitting/receiving circuit 3 or the GPS receiving circuit 4 is activated, the EX-OR gate 8 and AND gate 9 produce a switch control signal. The switch 53 is controlled by the switch control signal, which realizes the aforementioned various connection modes.

As described above, in the second embodiment, although the external connection port 5 is shared in connecting the main transmitting/receiving circuit 3 and the external apparatus and in connecting the GPS receiving circuit 4 and the external apparatus, the port 5 makes it possible to connect the main transmitting/receiving circuit 3 and the GPS receiving circuit 4 to the first built-in antenna 51, second built-in antenna 52, and the external apparatus suitably.

(Third Embodiment)

FIG. 7 shows a configuration of the main part of a portable communication apparatus according to a third embodiment of the present invention and a configuration of the main part of a car kit as an external apparatus. In FIG. 7, the same parts as those in FIG. 1 are indicated by the same reference numerals and a detailed explanation of them will be omitted.

As shown in FIG. 7, the portable communication apparatus of the third embodiment comprises a built-in antenna 1, a switch 2, a main transmitting/receiving circuit 3, a GPS receiving circuit 4, an external connection port 61, and a control section 62.

A car kit 71 is connected to the external connection port 61 as needed. The external connection port 61 has terminals 61a, 61b. The terminal 61a is capable of parallel connection with a plurality of signal lines. The terminal 61a is connected via the switch 2 to the main transmitting/receiving circuit 3 or GPS receiving circuit 4. The terminal 61b is capable of parallel connection with a plurality of signal lines. The terminal 61b is connected to the control section 62.

The control section 62, which includes, for example, a microprocessor, determines which of the main transmitting/receiving circuit 3 and GPS receiving circuit 4 to activate, on the basis of, for example, the operation mode specified by the user. In addition, the control section 62 tries to acquire type information from the car kit 71 via the terminal 61b and senses the connected state of the car kit 71 on the basis of the result of the acquisition of the type information or the contents of the acquired type information. Moreover, the control section 62 outputs a switch control signal according to the result of the determination or the result of the sensing.

In FIG. 7, numeral 71 indicates a car kit.

The car kit, which is provided with a connector 72, connects the connector 72 to the external connection port 61, thereby being connected to the portable communication apparatus.

The connector 72 has terminals 72a, 72b. The terminal 72a is capable of parallel connection with a plurality of signal lines. The terminal 72a is connected to the car kit 71. The terminal 72a comes into contact with the terminal 61a when the connector 72 is connected to the external connection port 61. The terminal 72b is capable of parallel connection with a plurality of signal lines. The terminal 72b comes into contact with the terminal 61b when the connector 72 is connected to the external connection port 61.

An external antenna 73 can be connected to the car kit 71. The car kit 71 connects the terminal 72a to the external antenna 73 via a known circuit (not shown), such as a booster.

In addition, the car kit 71 includes a setting switch 71a and a control section 71b.

The setting switch 71a is a switch that allows the user to do setting as to whether the external antenna 73 is adaptable for the reception of a GPS signal. The setting switch 71a informs the control section 71b of the contents of the setting.

The control section 71b, which includes, for example, a microprocessor, controls the operation of the car kit 71. According to the contents of the notice from the setting switch 71a, the control section 71b creates type information and gives the type information to the control section 62 via the terminal 72b.

Next, the operation of the portable communication apparatus of the third embodiment configured as described above will be explained.

Whether the car kit 71 is an external apparatus adaptable for the GPS receiving circuit 4 is determined, depending on whether the external antenna 73 to be connected is adaptable for the reception of a GPS signal. Therefore, the user sets the setting switch 71a to determine whether the external antenna 73 to be connected is adaptable for the reception of a GPS signal. Then, according to the setting of the setting switch 71a, the control section 71b creates type information to notify the portable communication apparatus whether the external apparatus is adaptable for the GPS receiving circuit 4.

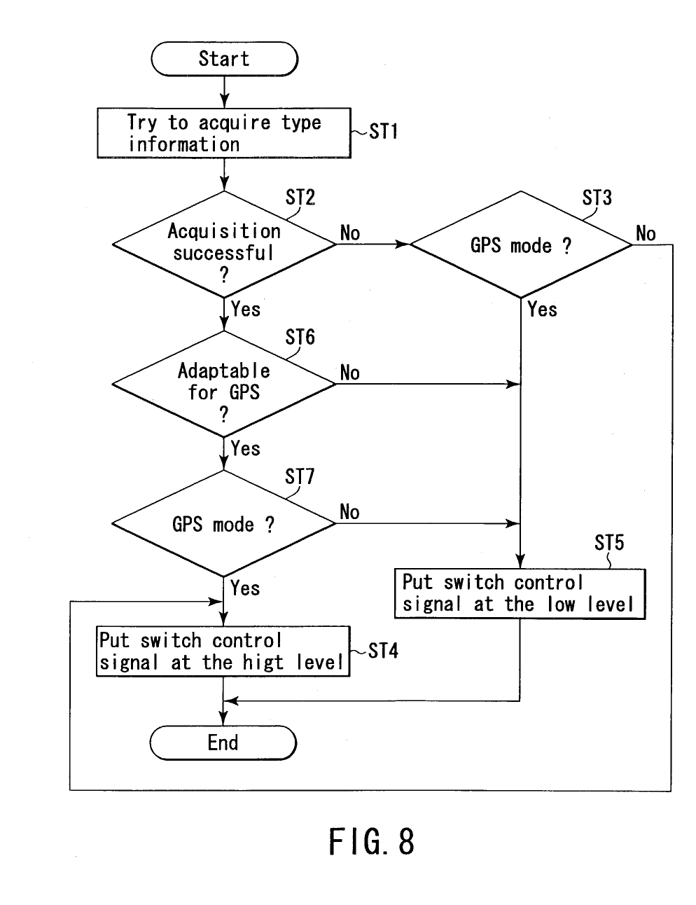

On the other hand, in the portable communication apparatus, the control section 62 executes a switch control process as shown in FIG. 8 with each specific timing, such as at specific intervals of time.

In the switch control process, the control section 62 tries to acquire type information via the terminal 61b in step ST1. Then, in step ST2, the control section 62 verifies whether type information has been acquired.

Here, if the car kit 71 has not been connected, the terminal 61b is in the open state, preventing the control section 62 from acquiring type information. Specifically, having verified in step ST2 that type information has not been acquired, the control section 62 senses that the car kit 72 has not been connected. In this case, the control section 62 verifies in step ST3 whether a GPS mode has been set. The GPS mode is an operation mode in which a position sensing process is carried out by use of the GPS receiving circuit 4.

In step ST3, having verified that the GPS mode has not been set, the control section 62 brings the switch control signal into the high level in step ST4. As a result, the switch 2 goes into the state shown in FIG. 2A, where the built-in antenna 1 is connected to the main transmitting/receiving circuit 3. In this state, a communication process can be carried out using the main transmitting/receiving circuit 3 and built-in antenna 1. That is, a normal communication operation can be performed via a mobile communication network.

In contrast, having verified in step ST3 that the GPS mode has been set, the control section 62 puts the switch control signal at the low level in step ST5. As a result, the switch 2 goes into the state shown in FIG. 2B, where the built-in antenna 1 is connected to the GPS receiving circuit 4. In this state, the GPS receiving circuit 4 can receive a GPS signal by use of the built-in antenna 1. That is, it is possible to perform a position sensing operation.

When the car kit 71 is connected to the external connection port 61 via the connector 72, the control section 62 can acquire type information from the control section 71b via the terminals 61b, 72b. After having verified in step ST2 that type information has been acquired, the control section 62 then verifies in step ST6 whether the car kit 71 is adaptable for the GPS receiving circuit 4, on the basis of the type information.

In step ST6, having verified that the car kit 71 is inadaptable for the GPS receiving circuit 4, the control section 62 puts the switch control signal at the low level in step ST5. As a result, the switch 2 goes into the state shown in FIG. 2B, where the main transmitting/receiving circuit 3 is connected to the terminal 5a and the built-in antenna 1 is connected to the GPS receiving circuit 4. In this state, when the main transmitting/receiving circuit 3 is in operation, a communication process can be carried out by use of the external antenna 73 via the car kit 7. Furthermore, when the GPS receiving circuit 4 is in operation, it is possible to receive a GPS signal by use of the built-in antenna 1.

In step ST6, having verified that the car kit 71 is adaptable for the GPS receiving circuit 4, the control section 62 then verifies in step ST7 whether the GPS mode has been set.

In step ST7, having verified that the GPS receiving circuit 4 is in operation, the control section 62 puts the switch control signal at the high level in step ST4. As a result, the switch 2 goes into the state shown in FIG. 2A, where the GPS receiving circuit 4 is connected to the terminal 5a. In this state, the GPS receiving circuit 4 can receive a GPS signal by use of the external antenna 73 via the car kit 71.

In contrast, having verified in step ST7 that the main transmitting/receiving circuit 3 is in operation, the control section 62 puts the switch control signal at the low level in step ST5. As a result, the switch 2 goes into the state shown in FIG. 2B, where the main transmitting/receiving circuit 3 is connected to the terminal 5a. In this state, the main transmitting/receiving circuit 3 can carry out a communication process by use of the external antenna 73 via the car kit 71.

After the process in step ST4 or step ST5 has been completed, the control section 62 completes the switch control process.

As described above, in the third embodiment, the portable communication apparatus enables the switch 2 to selectively connect the main transmitting/receiving circuit 3 and GPS receiving circuit 4 to the built-in antenna 1 and external connection port 5. The external connection port 5 is provided with the terminal 61b, which makes it possible to take in the type information outputted from the control section of the car kit 71.

The car kit 71 can output at the terminal 72b type information indicating whether it is adaptable for the GPS receiving circuit 4.

In this way, the portable communication apparatus can verify the connected state of the car kit 71 according to the result of acquiring the type information via the terminal 61b. Then, on the basis of the connected state of the car kit 71 and the operation mode, the control section 62 controls the switch 2, thereby realizing the aforementioned various connection modes.

As described above, in the third embodiment, although the external connection port 61 is shared in connecting the main transmitting/receiving circuit 3 and the car kit 71 and in connecting the GPS receiving circuit 4 and the car kit 71, the port 61 makes it possible to connect the main transmitting/receiving circuit 3 and the GPS receiving circuit 4 to the built-in antenna 1 and the car kit 71 suitably.

The present invention is not limited to the above-described embodiments. For instance, while in each of the above embodiments, it has determined whether or not an external apparatus is adaptable for the GPS receiving circuit 4, more than one condition for the GPS receiving circuit 4 may be determined.

When there are two types of maintenance apparatuses one of which is adaptable and the other of which is inadaptable for the GPS receiving circuit 4, they may be differentiated in the same manner as the external antennas and the connection modes may be changed according to the result of the differentiation.

While in each of the above embodiments, all of the external apparatuses have been assumed to be adaptable for the main transmitting/receiving circuit 3, an eternal apparatus adaptable only for the GPS receiving circuit 4 may be connected. In this case, whether the external apparatus has been connected is sensed. When it is sensed that the external apparatus has been connected, the main transmitting/receiving circuit 3 is connected to a corresponding built-in antenna and the GPS receiving circuit 4 is connected to the external connection port.

In the third embodiment, too, a maintenance apparatus may be connected to the external connection port 61. In this case, the maintenance apparatus is provided with the function of outputting type information, which enables an external antenna to be connected directly to the external connection port 61.

An external apparatus is not restricted to a maintenance apparatus, an external antenna, and a car kit in the above embodiments and may be any suitable apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable communication apparatus comprising:
a first circuit configured to communicate over a communication network;
a second circuit configured to receive a position sensing signal;
an antenna configured to be adaptable for both of the first and second circuits;
a port configured to connect to an external apparatus;
a switch configured to connect the first and second circuits to the antenna and the port;
a first detecting unit configured to detect whether the external apparatus is connected to the port and detect a type of the external apparatus connected to the port;
a second detecting unit configured to detect whether the first circuit or the second circuit is activated; and
a control unit configured to control the switch, when the first detecting unit detects that the external apparatus is not connected to the port or when the detected type of the external apparatus is inadaptable for the circuit to be activated, the circuit to be activated is connected to the antenna and that, when the detected type of the external apparatus is adaptable for the circuit to be activated, the circuit to be activated is connected to the port.

2. The portable communication apparatus according to claim 1, wherein the first detecting unit detects whether the external apparatus connected to the port is adaptable for the second circuit, and
the control unit controls the switch, when the external apparatus is connected to the port and the first circuit is to be activated, the first circuit is connected to the port and that, when the external apparatus is connected to the port, the second circuit is to be activated, and the first detecting unit detected that the external apparatus is adaptable for the second circuit, the second circuit is connected to the port.

3. The portable communication apparatus according to claim 1, wherein the antenna is adaptable for both of the first and second circuits, and
the control unit controls the switch, when it is detected that the external apparatus is not connected or when the detected type of the external apparatus is inadaptable for the circuit to be activated, the circuit to be activated is connected to the antenna.

4. The portable communication apparatus according to claim 1, wherein the antenna includes a first antenna for the first circuit and a second antenna for the second circuit,
the switch connects the first and second circuits to the first antenna, the second antenna, and the port, and
the control unit controls the switch, when it is detected that the external apparatus is not connected to the port or when the detected type of the external apparatus is inadaptable for the circuit to be activated, if the first circuit is to be activated, the first circuit is connected to the first antenna, whereas if the second circuit is to be activated, the second circuit is connected to the second antenna.

5. An external apparatus connectable to a portable communication apparatus including a first circuit configured to communicate over a communication network, a second circuit configured to receive a position sensing signal, an antenna configured to be adaptable for both of the first and second circuits, a port configured to connect to the external apparatus, a switch configured to connect the first and second circuits to the antenna and the port, a first detecting unit configured to detect whether the external apparatus is connected to the port and detect a type of the external apparatus connected to the port and a second detecting unit configured to detect whether the first circuit or the second circuit is activated, the external apparatus comprising:
a notification unit configured to notify the portable communication apparatus of a type of the external apparatus detected by the first detecting unit.

6. The external apparatus according to claim 5, wherein the type indicates the adaptability for the second circuit.

7. A portable communication apparatus comprising:
a first circuit configured to communicate over a communication network;
a second circuit configured to receive a position sensing signal;
an antenna configured to be adaptable for both of the first and second circuits;
a port configured to connect with an external apparatus;
a switch configured to connect the first and second circuits to the antenna and port;
a first detecting unit configured to detect whether the external apparatus is connected to the port and detect a type of the external apparatus connected to the port;
a second detecting unit configured to detect whether the first circuit or the second circuit is activated; and
a control unit configured to control the switch, when it is detected that the second circuit is to be activated and the type of the external apparatus is adaptable for the second circuit, the second circuit is connected to the port and that, when it is detected that the type of the external apparatus is inadaptable for the second circuit, the second circuit is connected to the antenna.

8. The portable communication apparatus according to claim 7, wherein the control unit controls the switch, when it is detected that the external apparatus is not connected to the port and when the second circuit is to be activated, the second circuit is connected to the antenna.

9. The portable communication apparatus according to claim 7, wherein the control unit controls the switch, when it is detected that the external apparatus is connected to the port and when the first circuit is to be activated, the first circuit is connected to the port.

10. An external apparatus connectable to a portable communication apparatus including a first circuit configured to communicate over a communication network, a second circuit configured to receive a position sensing signal, an antenna configured to be adaptable for both of the first and second circuits, a port configured to connect to the external apparatus, a switch configured to connect the first and second circuits to the antenna and the port, a first detecting unit configured to detect whether the external apparatus is connected to the port and detect a type of the external apparatus connected to the port and a second detecting unit configured to detect whether the first circuit or the second circuit is activated, the external apparatus comprising:
notification unit configured to notify the portable communication apparatus of a type of the external apparatus detected by the first detecting unit.

11. The external apparatus according to claim 10, wherein the notification unit notifies the adaptability for the second circuit.

12. A method of controlling a portable communication apparatus including a first circuit configured to communicate over a communication network, a second circuit configured to receive a position sensing signal, an antenna configured to be adaptable for both of the first and second circuits, a port configured to connect with an external apparatus, and a switch configured to connect the first and second circuits to the antenna and port, the method comprising:
detecting whether the external apparatus is connected to the port and detecting a type of the external apparatus connected to the port;
detecting whether the first circuit or the second circuit is activated; and
controlling the switch when it is detected that the external apparatus is not connected to the port or when the detected type of the external apparatus is inadaptable for the circuit to be activated, the circuit to be activated is connected to the antenna and that, when the detected type of the external apparatus is adaptable for the circuit to be activated, the circuit to be activated is connected to the port.
